(19) United States
(12) Patent Application Publication
(10) Pub. No.: US 2024/0214753 A1
(43) Pub. Date: Jun. 27, 2024

(54) ROTATABLY ADJUSTABLE FIXATION SYSTEM FOR MEDICAL IMPLANT

(71) Applicant: Cochlear Limited, Macquarie University, New South Wales (AU)

(72) Inventors: Stijn Eeckhoudt, Keerbergen (BE); Floriaan Van Reusel, Mechelen (BE)

(21) Appl. No.: 18/555,623

(22) PCT Filed: Apr. 29, 2022
(86) PCT No.: PCT/IB2022/054011

§ 371 Date: Oct. 16, 2023

Related U.S. Application Data
(60) Provisional application No. 63/183,988, filed on May 4, 2021.

(51) Int. Cl. H04R 25/00

(52) U.S. Cl. CPC H04R 25/606; H04R 2225/67

(57) ABSTRACT

An apparatus configured to be implanted within a portion of a recipient's body includes a fixation element having a socket and a transducer configured to be received by the socket. The transducer includes a first end portion configured to transmit signals to and/or receive signals from a target portion of the recipient's body. The transducer further includes a second end portion opposite to the first end portion, the first and second end portions spaced from one another along a center longitudinal axis of the transducer. The transducer further includes a surface at the first end portion or between the first and second end portions, the surface configured to be in mechanical communication with the socket with the center longitudinal axis of the transducer extending through the socket. The transducer is configured to be rotated such that an angular orientation of the center longitudinal axis relative to the socket is controllably adjusted.

### BACKGROUND

### Field

The present application relates generally to medical implants (e.g., implantable medical prostheses) having active components (e.g., transducers; actuators; microphones; sensors).

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises a fixation element configured to be implanted within a portion of a recipient's body, the fixation element comprising a socket. The apparatus further comprises a transducer configured to be implanted within the recipient's body and received by the socket. The transducer comprises a first end portion configured to transmit signals to and/or receive signals from a target portion of the recipient's body. The transducer further comprises a second end portion opposite to the first end portion, the first and second end portions spaced from one another along a center longitudinal axis of the transducer. The transducer further comprises a surface at the first end portion or between the first and second end portions, the surface configured to be in mechanical communication with the socket with the center longitudinal axis of the transducer extending through the socket. The transducer is configured to be rotated such that an angular orientation of the center longitudinal axis relative to the socket is controllably adjusted.

In another aspect disclosed herein, a method comprises affixing a mounting assembly to a location within a recipient's body. The mounting assembly comprises a receptacle configured to receive a transducer assembly. The receptacle comprises a substantially concave surface and an opening extending from the substantially concave surface through the receptacle. The substantially concave surface is substantially circular or spherical. The method further comprises adjusting a position of the receptacle such that the opening substantially faces a target portion of the recipient's body. The method further comprises inserting the transducer assembly into the receptacle with a substantially convex surface of the transducer assembly engaging the substantially concave surface of the receptacle. The substantially convex surface is substantially circular or spherical. The method further comprises adjusting an orientation of the substantially convex surface relative to the substantially concave surface. The method further comprises affixing the transducer assembly and the receptacle to one another.

In another aspect disclosed herein, an apparatus comprises a mounting assembly comprising a first portion, a second portion, and a receptacle. The first portion is configured to be affixed to a location of a recipient's body. The second portion is in mechanical communication with the first portion and is configured to extend into a region of the recipient's body spaced from the location of the recipient's body. The receptacle is in mechanical communication with the second portion. The receptacle comprises a first curved surface and an opening through the first curved surface. The receptacle is configured to be in mechanical communication with a transducer assembly comprising a second curved surface configured to fit with the first curved surface and to be rotatably adjusted relative to the first curved surface. The transducer assembly is configured to transmit signals to and/or receive signals from a target portion of the recipient's body along a line extending through the opening.

### BRIEF DESCRIPTION OF THE DRAWINGS

Implementations are described herein in conjunction with the accompanying drawings, in which:

FIG. 1 is a perspective view of an example cochlear implant auditory prosthesis implanted in a recipient in accordance with certain implementations described herein;

FIG. 2 is a perspective view of an example fully implantable middle ear implant auditory prosthesis implanted in a recipient in accordance with certain implementations described herein;

FIGS. 3A and 3B schematically illustrate two examples of an apparatus in accordance with certain implementations described herein;

FIG. 3C schematically illustrates an example apparatus positioned within a portion of the recipient's body and based on a two-point fixation concept in accordance with certain implementations described herein;

FIG. 4 schematically illustrates a cross-sectional view of an example apparatus in accordance with certain implementations described herein;

FIG. 5 schematically illustrates a cross-sectional view of another example apparatus in accordance with certain implementations described herein;

FIG. 6 schematically illustrates a cross-sectional view of an example socket comprising a substantially circularly curved first surface portion and an example transducer with the surface comprising a substantially circularly curved second surface portion in accordance with certain implementations described herein;

FIGS. 7A-7D schematically illustrate an example socket comprising a substantially spherically curved first surface portion and an example transducer with the surface comprising a substantially spherically curved second surface portion in accordance with certain implementations described herein; and

FIG. 8 is a flow diagram of an example method in accordance with certain implementations described herein.

### DETAILED DESCRIPTION

Certain implementations described herein provide a fixation system for a transducer assembly comprising an active component (e.g., microphone; tube microphone; actuator; middle ear actuator) that allows for increased angular adjustment of the active component relative to a target position within the recipient's body (e.g., an incus). The fixation system can provide an angular joint (e.g., rotation surface; ball joint mechanism) that is located at a front portion of the transducer assembly or between the front portion and a back portion of the transducer assembly. The angular joint can be integrated with the portion of the outer wall of the transducer assembly that is closest to the target position. By avoiding having the angular joint behind the active component, the fixation system can allow the angular joint to be positioned closer to the target position within the recipient's body, thereby providing a larger rotational degree of freedom for positioning the active component. In some implementations, the fixation system can be simpler (e.g., fewer degrees of freedom), more robust, less expensive, fewer components, and/or easier to manipulate and/or maneuver into position than previously-reported fixation systems.

The teachings detailed herein are applicable, in at least some implementations, to any type of implantable medical system utilizing an implantable transducer assembly configured to provide stimulation signals and/or medicament dosages to a portion of the recipient's body in response to received information and/or control signals (e.g., implantable sensor prostheses; implantable stimulation system; implantable medicament administration system). For example, the implantable medical system can comprise an auditory prosthesis system configured to generate and apply stimulation signals that are perceived by the recipient as sounds (e.g., evoking a hearing percept). Such implantable transducer assemblies can include but are not limited to: electro-acoustic electrical/acoustic systems, cochlear implant devices, implantable hearing aid devices, middle ear implant devices, bone conduction devices (e.g., active bone conduction devices; passive bone conduction devices, percutaneous bone conduction devices; transcutaneous bone conduction devices), Direct Acoustic Cochlear Implant (DACI), middle ear transducer (MET), electro-acoustic implant devices, other types of auditory prosthesis devices (e.g., auditory brain stimulators), and/or combinations or variations thereof, or any other suitable hearing prosthesis system with or without one or more external components. Merely for ease of description, apparatus and methods disclosed herein are primarily described with reference to an illustrative auditory prosthesis system, namely a middle ear implant, but implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses.

The teachings detailed herein and/or variations thereof may also be used with a variety of other medical devices that provide a wide range of therapeutic benefits to recipients, patients, or other users. For example, other sensory prosthesis systems that are configured to evoke other types of neural or sensory (e.g., sight, tactile, smell, taste) percepts are compatible with certain implementations described herein, including but are not limited to: vestibular devices (e.g., vestibular implants), visual devices (e.g., bionic eyes), visual prostheses (e.g., retinal implants), somatosensory implants, and chemosensory implants. In some implementations, the teachings detailed herein and/or variations thereof can be utilized in other types of implantable medical devices beyond sensory prostheses. For example, apparatus and methods disclosed herein and/or variations thereof can be used with one or more of the following: sensors; cardiac pacemakers; drug delivery systems; defibrillators; functional electrical stimulation devices; catheters; brain implants; seizure devices (e.g., devices for monitoring and/or treating epileptic events); sleep apnea devices; electroporation; pain relief devices; etc. Implementations can include any type of medical system that can utilize the teachings detailed herein and/or variations thereof (e.g., systems that may benefit from having an adjustable orientation of at least a portion of the implanted device during implantation).

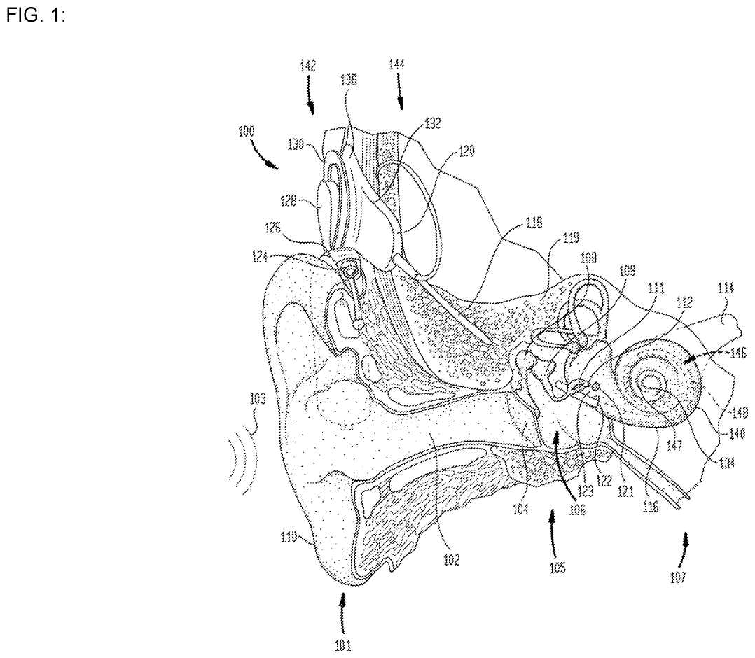

FIG. 1 is a perspective view of an example cochlear implant auditory prosthesis 100 implanted in a recipient in accordance with certain implementations described herein. The example auditory prosthesis 100 is shown in FIG. 1 as comprising an implanted stimulator unit 120 and a microphone assembly 124 that is external to the recipient (e.g., a partially implantable cochlear implant). An example auditory prosthesis 100 (e.g., a totally implantable cochlear implant; a mostly implantable cochlear implant) in accordance with certain implementations described herein can replace the external microphone assembly 124 shown in FIG. 1 with a subcutaneously implantable microphone assembly, as described more fully herein. In certain implementations, the example cochlear implant auditory prosthesis 100 of FIG. 1 can be in conjunction with a reservoir of liquid medicament as described herein.

As shown in FIG. 1, the recipient has an outer ear 101, a middle ear 105, and an inner ear 107. In a fully functional ear, the outer ear 101 comprises an auricle 110 and an ear canal 102. An acoustic pressure or sound wave 103 is collected by the auricle 110 and is channeled into and through the ear canal 102. Disposed across the distal end of the ear canal 102 is a tympanic membrane 104 which vibrates in response to the sound wave 103. This vibration is coupled to oval window or fenestra ovalis 112 through three bones of middle ear 105, collectively referred to as the ossicles 106 and comprising the malleus 108, the incus 109, and the stapes 111. The bones 108, 109, and 111 of the middle ear 105 serve to filter and amplify the sound wave 103, causing the oval window 112 to articulate, or vibrate in response to vibration of the tympanic membrane 104. This vibration sets up waves of fluid motion of the perilymph within cochlea 140. Such fluid motion, in turn, activates tiny hair cells (not shown) inside the cochlea 140. Activation of the hair cells causes appropriate nerve impulses to be generated and transferred through the spiral ganglion cells (not shown) and auditory nerve 114 to the brain (also not shown) where they are perceived as sound.

As shown in FIG. 1, the example auditory prosthesis 100 comprises one or more components which are temporarily or permanently implanted in the recipient. The example auditory prosthesis 100 is shown in FIG. 1 with an external component 142 which is directly or indirectly attached to the recipient's body, and an internal component 144 which is temporarily or permanently implanted in the recipient (e.g., positioned in a recess of the temporal bone adjacent auricle 110 of the recipient). The external component 142 typically comprises one or more sound input elements (e.g., an external microphone 124) for detecting sound, a sound processing unit 126 (e.g., disposed in a Behind-The-Ear unit), a power source (not shown), and an external transmitter unit 128. In the illustrative implementations of FIG. 1, the external transmitter unit 128 comprises an external coil 130 (e.g., a wire antenna coil comprising multiple turns of electrically insulated single-strand or multi-strand platinum or gold wire) and, preferably, a magnet (not shown) secured directly or indirectly to the external coil 130. The external coil 130 of the external transmitter unit 128 is part of an inductive radio frequency (RF) communication link with the internal component 144. The sound processing unit 126 processes the output of the microphone 124 that is positioned externally to the recipient's body, in the depicted implementation, by the recipient's auricle 110. The sound processing unit 126 processes the output of the microphone 124 and generates encoded signals, sometimes referred to herein as encoded data signals, which are provided to the external transmitter unit 128 (e.g., via a cable). As will be appreciated, the sound processing unit 126 can utilize digital processing techniques to provide frequency shaping, amplification, compression, and other signal conditioning, including conditioning based on recipient-specific fitting parameters.

The power source of the external component 142 is configured to provide power to the auditory prosthesis 100, where the auditory prosthesis 100 includes a battery (e.g., located in the internal component 144, or disposed in a separate implanted location) that is recharged by the power provided from the external component 142 (e.g., via a transcutaneous energy transfer link). The transcutaneous energy transfer link is used to transfer power and/or data to the internal component 144 of the auditory prosthesis 100. Various types of energy transfer, such as infrared (IR), electromagnetic, capacitive, and inductive transfer, may be used to transfer the power and/or data from the external component 142 to the internal component 144. During operation of the auditory prosthesis 100, the power stored by the rechargeable battery is distributed to the various other implanted components as needed.

The internal component 144 comprises an internal receiver unit 132, a stimulator unit 120, and an elongate electrode assembly 118. In some implementations, the internal receiver unit 132 and the stimulator unit 120 are hermetically sealed within a biocompatible housing. The internal receiver unit 132 comprises an internal coil 136 (e.g., a wire antenna coil comprising multiple turns of electrically insulated single-strand or multi-strand platinum or gold wire), and preferably, a magnet (also not shown) fixed relative to the internal coil 136. The internal receiver unit 132 and the stimulator unit 120 are hermetically sealed within a biocompatible housing, sometimes collectively referred to as a stimulator/receiver unit. The internal coil 136 receives power and/or data signals from the external coil 130 via a transcutaneous energy transfer link (e.g., an inductive RF link). The stimulator unit 120 generates electrical stimulation signals based on the data signals, and the stimulation signals are delivered to the recipient via the elongate electrode assembly 118.

The elongate electrode assembly 118 has a proximal end connected to the stimulator unit 120, and a distal end implanted in the cochlea 140. The electrode assembly 118 extends from the stimulator unit 120 to the cochlea 140 through the mastoid bone 119. In some implementations, the electrode assembly 118 may be implanted at least in the basal region 116, and sometimes further. For example, the electrode assembly 118 may extend towards apical end of cochlea 140, referred to as cochlea apex 134. In certain circumstances, the electrode assembly 118 may be inserted into the cochlea 140 via a cochleostomy 122. In other circumstances, a cochleostomy may be formed through the round window 121, the oval window 112, the promontory 123, or through an apical turn 147 of the cochlea 140.

The elongate electrode assembly 118 comprises a longitudinally aligned and distally extending array 146 of electrodes or contacts 148, sometimes referred to as electrode or contact array 146 herein, disposed along a length thereof. Although the electrode array 146 can be disposed on the electrode assembly 118, in most practical applications, the electrode array 146 is integrated into the electrode assembly 118 (e.g., the electrode array 146 is disposed in the electrode assembly 118). As noted, the stimulator unit 120 generates stimulation signals which are applied by the electrodes 148 to the cochlea 140, thereby stimulating the auditory nerve 114.

While FIG. 1 schematically illustrates an auditory prosthesis 100 utilizing an external component 142 comprising an external microphone 124, an external sound processing unit 126, and an external power source, in certain other implementations, one or more of the microphone 124, sound processing unit 126, and power source are implantable on or within the recipient (e.g., within the internal component 144). For example, the auditory prosthesis 100 can have each of the microphone 124, sound processing unit 126, and power source implantable on or within the recipient (e.g., encapsulated within a biocompatible assembly located subcutaneously), and can be referred to as a totally implantable cochlear implant (“TICI”). For another example, the auditory prosthesis 100 can have most components of the cochlear implant (e.g., excluding the microphone, which can be an in-the-ear-canal microphone) implantable on or within the recipient, and can be referred to as a mostly implantable cochlear implant (“MICI”).

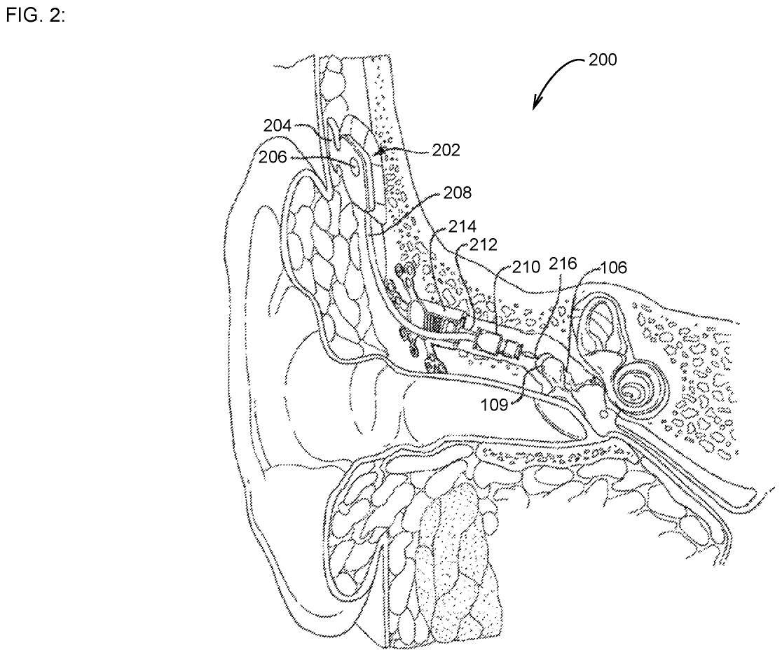

FIG. 2 schematically illustrates a perspective view of an example fully implantable auditory prosthesis 200 (e.g., fully implantable middle ear implant or totally implantable acoustic system), implanted in a recipient, utilizing an acoustic actuator in accordance with certain implementations described herein. The example auditory prosthesis 200 of FIG. 2 comprises a biocompatible implantable assembly 202 (e.g., comprising an implantable capsule) located subcutaneously (e.g., beneath the recipient's skin and on a recipient's skull). While FIG. 2 schematically illustrates an example implantable assembly 202 comprising a microphone, in other example auditory prostheses 200, a pendant microphone can be used (e.g., connected to the implantable assembly 202 by a cable). The implantable assembly 202 includes a signal receiver 204 (e.g., comprising a coil element) and an acoustic transducer 206 (e.g., a microphone comprising a diaphragm and an electret or piezoelectric transducer) that is positioned to receive acoustic signals through the recipient's overlying tissue. The implantable assembly 202 may further be utilized to house a number of components of the fully implantable auditory prosthesis 200. For example, the implantable assembly 202 can include an energy storage device and a signal processor (e.g., a sound processing unit). Various additional processing logic and/or circuitry components can also be included in the implantable assembly 202 as a matter of design choice.

For the example auditory prosthesis 200 shown in FIG. 2, the signal processor of the implantable assembly 202 is in operative communication (e.g., electrically interconnected via a wire 208) with an actuator 210 (e.g., comprising a transducer configured to generate mechanical vibrations in response to electrical signals from the signal processor). In certain implementations, the example auditory prosthesis 100, 200 shown in FIGS. 1 and 2 can comprise an implantable microphone assembly, such as the microphone assembly 206 shown in FIG. 2. For such an example auditory prosthesis 100, the signal processor of the implantable assembly 202 can be in operative communication (e.g., electrically interconnected via a wire) with the microphone assembly 206 and the stimulator unit of the main implantable component 120. In certain implementations, at least one of the microphone assembly 206 and the signal processor (e.g., a sound processing unit) is implanted on or within the recipient.

The actuator 210 of the example auditory prosthesis 200 shown in FIG. 2 is supportably connected to a positioning system 212, which in turn, is connected to a bone anchor 214 mounted within the recipient's mastoid process (e.g., via a hole drilled through the skull). The actuator 210 includes a connection apparatus 216 for connecting the actuator 210 to the ossicles 106 of the recipient. In a connected state, the connection apparatus 216 provides a communication path for acoustic stimulation of the ossicles 106 (e.g., through transmission of vibrations from the actuator 210 to the incus 109).

During normal operation, ambient acoustic signals (e.g., ambient sound) impinge on the recipient's tissue and are received transcutaneously at the microphone assembly 206. Upon receipt of the transcutaneous signals, a signal processor within the implantable assembly 202 processes the signals to provide a processed audio drive signal via wire 208 to the actuator 210. As will be appreciated, the signal processor may utilize digital processing techniques to provide frequency shaping, amplification, compression, and other signal conditioning, including conditioning based on recipient-specific fitting parameters. The audio drive signal causes the actuator 210 to transmit vibrations at acoustic frequencies to the connection apparatus 216 to affect the desired sound sensation via mechanical stimulation of the incus 109 of the recipient.

The subcutaneously implantable microphone assembly 202 is configured to respond to auditory signals (e.g., sound; pressure variations in an audible frequency range) by generating output signals (e.g., electrical signals; optical signals; electromagnetic signals) indicative of the auditory signals received by the microphone assembly 202, and these output signals are used by the auditory prosthesis 100, 200 to generate stimulation signals which are provided to the recipient's auditory system. To compensate for the decreased acoustic signal strength reaching the microphone assembly 202 by virtue of being implanted, the diaphragm of an implantable microphone assembly 202 can be configured to provide higher sensitivity than are external non-implantable microphone assemblies. For example, the diaphragm of an implantable microphone assembly 202 can be configured to be more robust and/or larger than diaphragms for external non-implantable microphone assemblies.

The example auditory prostheses 100 shown in FIG. 1 utilizes an external microphone 124 and the auditory prosthesis 200 shown in FIG. 2 utilizes an implantable microphone assembly 206 comprising a subcutaneously implantable acoustic transducer. In certain implementations described herein, the auditory prosthesis 100 utilizes one or more implanted microphone assemblies on or within the recipient. In certain implementations described herein, the auditory prosthesis 200 utilizes one or more microphone assemblies that are positioned external to the recipient and/or that are implanted on or within the recipient, and utilizes one or more acoustic transducers (e.g., actuator 210) that are implanted on or within the recipient. In certain implementations, an external microphone assembly can be used to supplement an implantable microphone assembly of the auditory prosthesis 100, 200. Thus, the teachings detailed herein and/or variations thereof can be utilized with any type of external or implantable microphone arrangement, and the acoustic transducers shown in FIGS. 1 and 2 are merely illustrative.

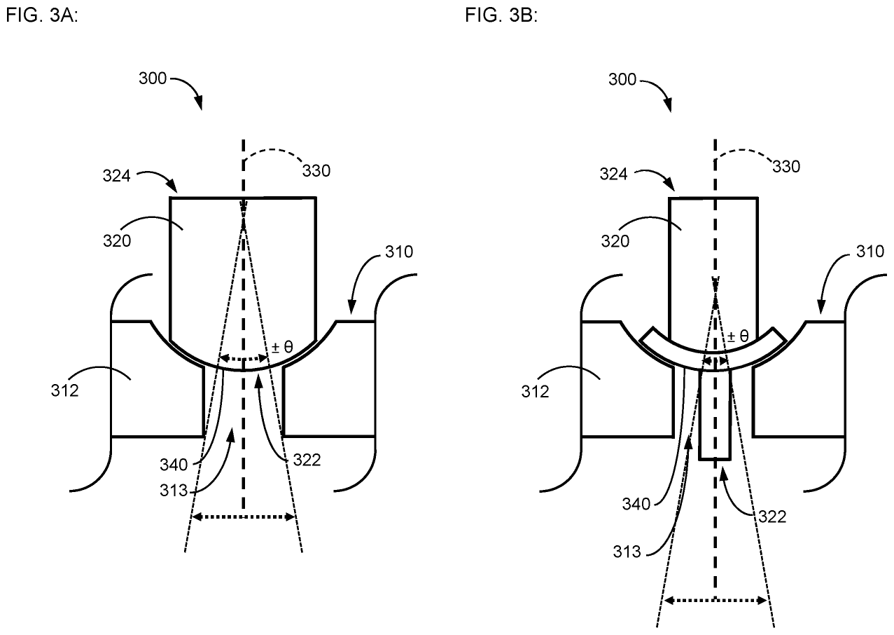

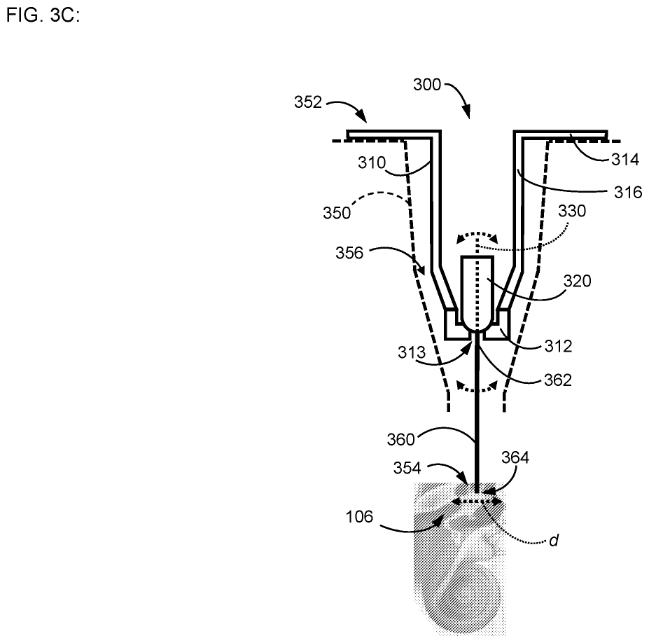

FIGS. 3A and 3B schematically illustrate two examples of an apparatus 300 in accordance with certain implementations described herein. The apparatus 300 comprises a fixation element 310 configured to be implanted within a portion of a recipient's body. The fixation element 310 comprising a socket 312. The apparatus 300 further comprises a transducer 320 configured to be implanted within the recipient's body and received by the socket 312. The transducer 320 comprises a first end portion 322 configured to transmit signals to and/or receive signals from a target portion of the recipient's body. The transducer 320 further comprises a second end portion 324 opposite to the first end portion 322, the first and second end portions 322, 324 spaced from one another along a center longitudinal axis 330 of the transducer 320. The transducer 320 further comprises a surface 340 at the first end portion 322 or between the first and second end portions 322, 324. The surface 340 is configured to be in mechanical communication with the socket 312 with the center longitudinal axis 330 of the transducer 320 extending through the socket 312. The transducer 320 is configured to be rotated such that an angular orientation of the center longitudinal axis 330 relative to the socket 312 is controllably adjusted. FIG. 3A shows an example apparatus 300 in which the surface 340 is at the first end portion 322 (e.g., the transducer 320 does not extend through an orifice 313 of the socket 312) and FIG. 3B shows an example apparatus 300 in which the surface 340 is between the first and second end portions 322, 324 (e.g., the transducer 320 extends through an orifice 313 of the socket 312). For example, the surface 340 can be a substantially spherical or circular surface of a plate (e.g., disk) as schematically illustrated by FIG. 3B. In certain implementations, the surface 340 is retained within the socket 312 via a snap or friction fitting, a clamp or screw, and/or adhesive.

In certain implementations, the transducer 320 comprises an active component 326 (e.g., actuator; microphone; optical sensor; magnetic induction sensor) configured to be in operative communication with a target portion of the recipient's body (e.g., an ossicle 106, a portion of a cochlea 140, a portion of the otic capsule, or a semicircular canal of the recipient's body). For example, the transducer 320 can comprise an acoustic actuator (e.g., actuator 210) configured to generate mechanical vibrations at acoustic frequencies in response to electrical signals from a signal processor and to transmit the vibrations (e.g., via a connection apparatus 216) to the ossicles 106 of the recipient. For another example, the transducer 320 can comprise a microphone configured to sense or detect mechanical vibrations from a portion of the recipient's body (e.g., the ossicles 106) and to generate electrical and/or optical signals in response. The active component 326 of certain implementations is in mechanical communication with the target portion of the recipient's body (e.g., via a rod or wire extending from the first end portion 322 through the orifice 313 of the socket 312 and configured to be in mechanical communication with the target portion of the recipient's body such that mechanical vibrations propagate along the rod or wire between the transducer 320 and the target portion of the recipient's body). In certain other implementations, the active component 326 comprises a sensor (e.g., optical sensor; magnetic induction sensor) facing towards the target portion of the recipient's body (e.g., along a line-of-sight through the orifice 313) and configured to sense or detect motion (e.g., vibrations) of the target portion of the recipient's body. While certain implementations are described herein as comprising a transducer 320, in certain other implementations, the apparatus 300 comprises a different component (e.g., reservoir; valve; pump) configured to be in operative communication with the target portion of the recipient's body via a fluid conduit configured to provide at least one liquid medicament to the target portion of the recipient's body.

In certain implementations, the transducer 320 is configured to be rotated relative to the socket 312 such that the center longitudinal axis 330 of the transducer 320 can be aimed at a target position of the recipient's body. The rotation angle of the transducer 320 can be in a range of angles ±θ (e.g., ±15 degrees; ±10 degrees) such that the center longitudinal axis 330 can be rotatably aimed at target positions within a range of distances from the surface 340 (e.g., 5 millimeters to 40 millimeters; 5 millimeters to 15 millimeters and within a range of distances d (e.g., +2 millimeters; +1 millimeter) relative to a center position of the center longitudinal axis 330 (e.g., where the rotation angle is zero).

FIG. 3C schematically illustrates an example apparatus 300 positioned within a portion of the recipient's body and based on a two-point fixation concept in accordance with certain implementations described herein. The apparatus 300 is configured to be affixed to a first location 352 on or within the recipient's body and to be in operative communication with a second location 354 of the recipient's body (e.g., a target portion of the recipient's body; in an inner ear region; in a middle ear region; within a cochleovestibular region; on a cochlea 140), the first location 352 spaced from the second location 354 with the apparatus 300 bridging the physical gap between the first and second locations 352, 354.

For example, as shown in FIG. 3C, the example apparatus 300 can comprise a middle ear transducer assembly with the fixation element 310 (e.g., bracket) affixed to the first location 352 at a surface of the recipient's skull bone 350 (e.g., outer surface: top surface). The fixture 310 can be configured to extend at least partially within a region 356 (e.g., middle ear region; mastoid bone cavity; channel; cavity; naturally-occurring; drilled or otherwise formed through surgical techniques) extending through the skull bone 350 of the recipient. The transducer 320 can be in mechanical communication with the socket 312 of the fixation element 310 and in operative communication with the second location 354 at a middle ear target (e.g., an ossicle 106; incus 109). For another example, the first location 352 can comprise another surface of the recipient's body (e.g., a machined surface of the skull bone 350, an example of which is an inner surface of the region 356; a bottom surface of the skull bone 350).

In certain implementations, as schematically illustrated in FIG. 3C, the apparatus 300 further comprises a connection apparatus 360 (e.g., connection apparatus 216; rod; tube) having a first end 362 in mechanical communication with the transducer 320 (e.g., with the first end portion 322 of the transducer 320) and a second end 364 in mechanical communication with the second location 354 (e.g., target portion of the recipient's body; middle ear target). In certain such implementations, the connection apparatus 360 extends along the center longitudinal axis 330 of the transducer 320 (e.g., through the orifice 313 of the socket 312). The connection apparatus 360 of certain implementations comprises at least one biocompatible material (e.g., titanium; titanium alloy; plastic; ceramic) and has a length (e.g., in a range of 5 millimeters to 40 millimeters; in a range of 5 millimeters to 15 millimeters), an outer width or diameter (e.g., in a range of 0.1 millimeter to 1 millimeter; in a range of 0.1 millimeter to 0.2 millimeter), and/or an inner width or diameter (e.g., in a range of 0.1 millimeter to 1 millimeter; in a range of 0.1 millimeter to 0.2 millimeter). For example, the connection apparatus 360 can be configured to conduct mechanical vibrations from the transducer 320 to the middle ear target and/or from the middle ear target to the transducer 320. The connection apparatus 360 can be flexible while allowing vibrations at the second location 354 (e.g., ossicles 106) to propagate to the transducer 320 (e.g., microphone; tubular microphone assembly). For another example, the connection apparatus 360 can comprise a fluid conduit configured to be in fluidic communication with the second location 354 (e.g., in the middle and/or inner ear regions) and in fluidic communication with a reservoir, valve, and/or pump (e.g., in place of the transducer 320) configured to respond to control signals from a controller to controllably provide at least one liquid medicament to the second location 354.

In certain other implementations, the apparatus 300 does not comprise the connection apparatus 360 but the first end portion 322 is configured to be in operative communication with the second location 354 (e.g., target portion) of the recipient's body. For example, the transducer 320 can comprise a microphone having an optical or magnetic induction sensor facing away from the first end portion 322 towards the second location 354 (e.g., facing along the center longitudinal axis 330 of the transducer 320 through an orifice of the socket 312), the optical sensor configured to be responsive to relative motion (e.g., vibrations) of the second location 354 relative to the transducer 320.

In certain implementations, the fixation element 310 is configured to be affixed to a portion of the recipient's body and to hold the transducer 320. For example, as schematically illustrated by FIG. 3C, the fixation element 310 can comprise a first portion 314 comprising at least one biocompatible material (e.g., titanium; titanium alloy; plastic; ceramic) configured to be affixed to the first location 352 of the recipient's body (e.g., via screws, sutures, adhesive and/or osseointegration) and a second portion 316 comprising at least one biocompatible material (e.g., titanium; titanium alloy; plastic; ceramic) extending at least partially within the region 356 and in mechanical communication with the first portion 314 and the socket 312. In certain implementations, the first portion 314 and the second portion 316 are integral with one another, while in certain other implementations, the first portion 314 and the second portion 316 are separate components that are affixed to one another.

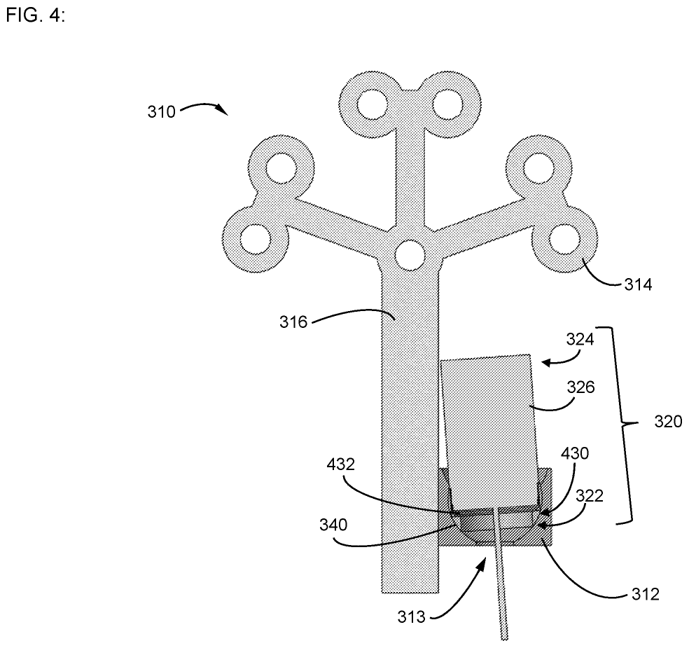

In certain implementations, the second portion 316 is configured to be adjusted to modify a position (e.g., linear position; depth within the region 356) and/or orientation of the socket 312 (e.g., relative to the target portion of the recipient's body; during implantation of the apparatus 300). FIG. 4 schematically illustrates a cross-sectional view of an example apparatus 300 in accordance with certain implementations described herein. The second portion 316 of certain implementations is configured to be plastically deformed (e.g., bent and/or twisted; controlled by a practitioner during implantation of the apparatus 300) such that the orifice 313 of the socket 312 is coarsely pointed towards the second location 354. In certain implementations, the socket 312 is configured to be linearly adjusted relative to the second portion 316 (e.g., by a distance of about 1 to 10 millimeters). For example, the second portion 316 can comprise a slot and a corresponding protrusion (not shown) in mechanical communication with the socket 312 and configured to mate with (e.g., extending within) and to controllably slide along the slot, such that the socket 312 can be slidably adjustable guided by the protrusion within the slot. In another example, the socket 312 can comprise the slot and the second portion 316 can comprise the corresponding protrusion. The socket 312 can comprise a clamp (e.g., pair of surfaces and/or at least one locking screw) configured to press against the second portion 316 to keep the socket 312 in place along the slot. In another example, the second portion 316 can comprise the clamp configured to hold the socket 312 in place. In another example, the socket 312 and the second portion 316 can comprise a plurality of interlocking (e.g., rachet) teeth configured to mate with one another to hold the socket 312 in place.

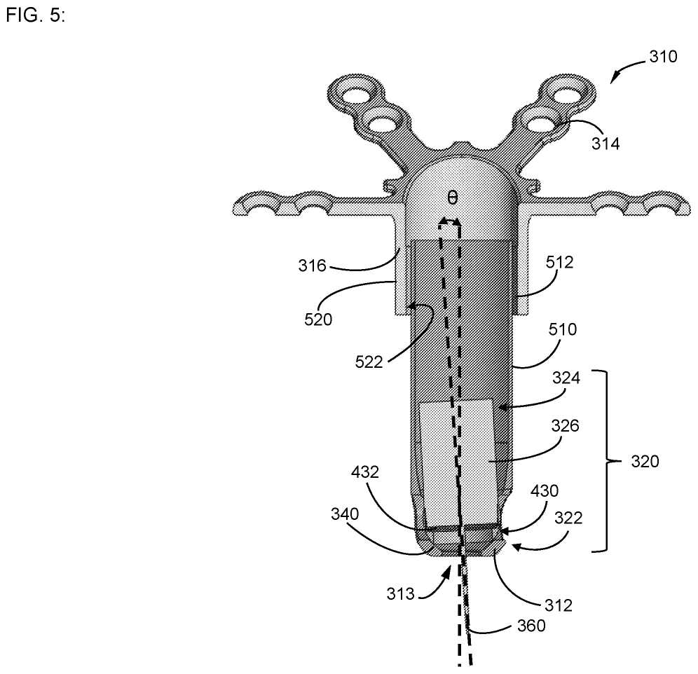

FIG. 5 schematically illustrates a cross-sectional view of another example apparatus 300 in accordance with certain implementations described herein. As shown in FIG. 5, the second portion 316 comprises a first substantially cylindrical portion 510 in mechanical communication with the socket 312 and having a screw thread 512 at an outside surface and a second substantially cylindrical portion 520 in mechanical communication with the first portion 314 and having a screw thread 522 at an inside surface. The screw thread 522 is configured to mate with the screw thread 512 such that rotation of the first substantially cylindrical portion 510 relative to the second substantially cylindrical portion 520 linearly adjusts the position of the socket 312. In certain other implementations, the screw thread 512 is at an inside surface and the screw thread 522 is at an outside surface. The second portion 316 of certain implementations comprises a clamp (e.g., at least one locking screw) configured to keep the first and second substantially cylindrical portions 510, 520 in place relative to one another. In this way, the socket 312 can be both rotationally adjusted and linearly adjusted relative to the target portion of the recipient's body and once adjusted, fixed in place.

In certain implementations, the substantially cylindrical portion 510 of the socket 312 has an inner diameter sufficiently large such that the orientation of the center longitudinal axis 330 of the transducer 320 within the socket 312 can be adjusted within a range of angles θ (e.g., ±10 degrees) relative to a center longitudinal axis 514 of the substantially cylindrical portion 510 of the socket 312. In certain implementations, the substantially cylindrical portion 510 of the socket 312 comprises an opening configured to allow the transducer 320 to be rotated by larger angles with the second end portion 324 of the transducer 320 extending outwardly from the opening and/or to provide visibility to the transducer 320 by the practitioner during implantation. The socket 312 of certain implementations is configured to be rotated substantially continuously relative to the second portion 316 to provide a continuous adjustment of the position and the orientation of the socket 312. In certain other implementations, the socket 312 is configured to be rotated at discrete positions and orientations relative to the second portion 316. For example, the substantially cylindrical portion 520 of the second portion 316 can also comprise an opening and the opening of the substantially cylindrical portion 510 of the socket 312 can be substantially aligned with the opening when the socket 312 is at discrete rotations relative to the second portion 316.

In certain implementations, the transducer 320 comprises the active component 326 (e.g., actuator; microphone; sensor) and a bearing portion 430 comprising the surface 340. In certain implementations, the bearing portion 430 and the transducer 320 are unitary with one another, while in certain other implementations, the bearing portion 430 and the transducer 320 are separate components configured to be affixed to one another. For example, as schematically illustrated by FIGS. 4 and 5, the bearing portion 430 comprises a generally hollow ring configured to be affixed to a portion 432 of the active component 326 (e.g., via a snap or friction fitting and/or adhesive). In certain such implementations in which the active component 326 comprises an actuator or microphone comprising a diaphragm within the portion 432, the bearing portion 430 comprises the first end portion 322 of the transducer 320 and the diaphragm is recessed from a front face of the transducer 320 thereby protecting the diaphragm.

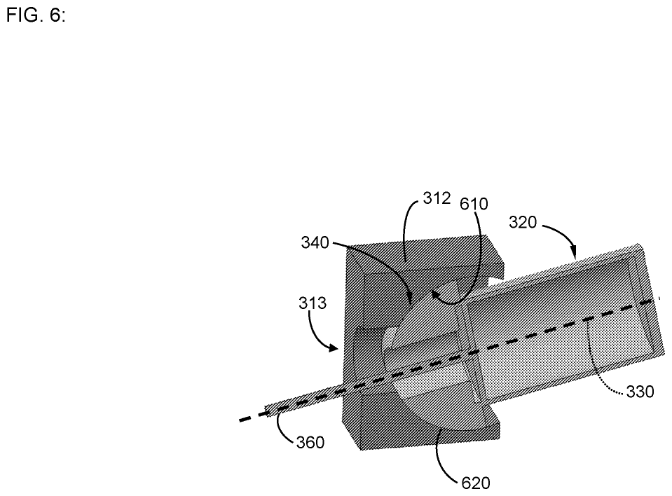

FIG. 6 schematically illustrates a cross-sectional view of an example socket 312 comprising a substantially circularly curved first surface portion 610 and an example transducer 320 with the surface 340 comprising a substantially circularly curved second surface portion 620 in accordance with certain implementations described herein. In FIG. 6, the substantially circularly curved first surface portion 610 is an inner surface portion of the socket 312 and the substantially circularly curved second surface portion 620 is an outer surface portion of the transducer 320, the second surface portion 620 configured to be in mechanical communication with and controllably positioned relative to the first surface portion 610. The inner radius of curvature of the first surface portion 610 can be substantially equal to the outer radius of curvature of the second surface portion 620 and the second surface portion 620 can have a center of curvature substantially coincident with a center of curvature of the first surface portion 610. In certain such implementations, the center longitudinal axis 330 extends through the orifice 313 of the socket 312 and the transducer 320 can be rotated about the center of curvature of the second surface portion 620 relative to the socket 312 with the center longitudinal axis 330 constrained to move within a range of angles within a rotational plane (e.g., the cross-sectional plane of FIG. 6).

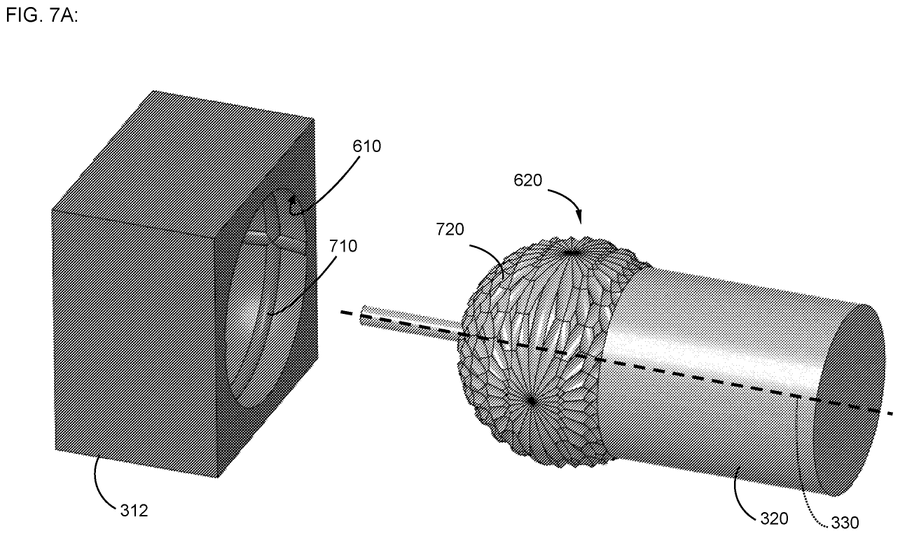

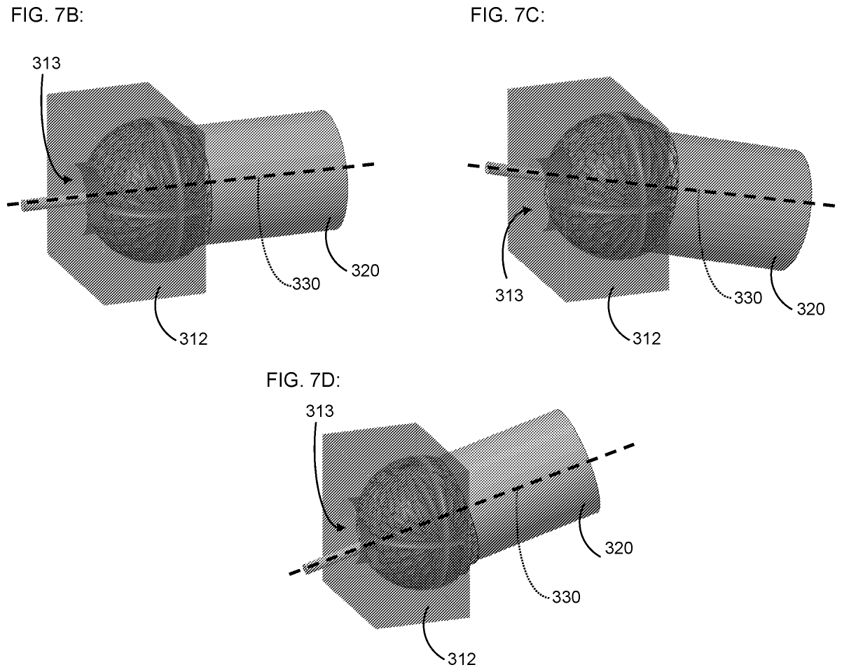

FIGS. 7A-7D schematically illustrate an example socket 312 comprising a substantially spherically curved first surface portion 610 and an example transducer 320 with the surface 340 comprising a substantially spherically curved second surface portion 620 in accordance with certain implementations described herein. FIGS. 7A and 7B schematically illustrate a partially exploded perspective view and an assembled perspective view, respectively, of the socket 312 and the transducer 320. FIGS. 7C and 7D schematically illustrate perspective views of the transducer 320 in mechanical communication with the socket 312 in a first position, a second position, and a third position, respectively. In FIGS. 7A-7D, the substantially spherically curved first surface portion 610 is an inner surface portion of the socket 312 and the substantially spherically curved second surface portion 620 is an outer surface portion of the transducer 320, the second surface portion 620 configured to be in mechanical communication with and controllably positioned relative to the first surface portion 610. As shown in FIGS. 7B-7D, the inner radius of curvature of the first surface portion 610 can be substantially equal to the outer radius of curvature of the second surface portion 620 and the second surface portion 620 can have a center of curvature substantially coincident with a center of curvature of the first surface portion 610. In certain such implementations, the center longitudinal axis 330 extends through the orifice 313 of the socket 312 and the transducer 320 can be rotated about the center of curvature of the second surface portion 620 relative to the socket 312 with the center longitudinal axis 330 movable within a range of angles within a spherical sector extending from the center of curvature through the orifice 313.

In certain implementations, one of the first surface portion 610 and the second surface portion 620 comprises a plurality of protrusions 710 and the other of the first surface portion 610 and the second surface portion 620 comprises a plurality of recesses 720 configured to mate with the plurality of protrusions 710. The plurality of protrusions 710 and the plurality of recesses 720 can be configured such that the center longitudinal axis 330 is positionable at a plurality of discrete angular orientations relative to the socket 312. For example, as schematically illustrated by FIGS. 7A-7D, the first surface portion 610 of the socket 312 comprises the plurality of protrusions 710 (e.g., two substantially linear ridges that are substantially perpendicular to one another) and the second surface portion 620 of the transducer 320 comprises the plurality of recesses 720 (e.g., an array of substantially linear grooves) configured to mate with the plurality of protrusions 710. As shown in FIGS. 7B-7D, the mating protrusions 710 and recesses 720 are configured to define discrete angular orientations of the transducer 320 relative to the socket 312. While FIGS. 7A-7D show the first surface portion 610 comprising the protrusions 710 and the second surface portion 620 comprising the recesses 720, in certain other implementations, the first surface portion 610 comprises the recesses 720 and the second surface portion 620 comprises the protrusions 710. Other types of protrusions 710 and recesses 720 are also compatible with certain implementations described herein. For example, the protrusions 710 can comprise a plurality of bumps (e.g., substantially convex portions) and the recesses 720 can comprise an array of dimples (e.g., substantially concave portions) configured to mate with the bumps.

In certain implementations, as schematically illustrated by FIGS. 6 and FIGS. 7A-7D, the apparatus 300 comprises a connection apparatus 360 (e.g., connection apparatus 216; rod; tube) extending from the transducer 320 along the center longitudinal axis 330 and through the orifice 313. In certain other implementations, the apparatus 300 does not comprise a connection apparatus 360, and the active component 326 of the transducer 320 comprises a sensor (e.g., an optical sensor) with a line-of-sight extending along the center longitudinal axis 330 through the orifice 313. In certain implementations, as schematically illustrated by FIGS. 6 and FIGS. 7B-7D, the orifice 313 is substantially circular, while in certain other implementations, the orifice 313 has other shapes (e.g., rectangular; square; asymmetric).

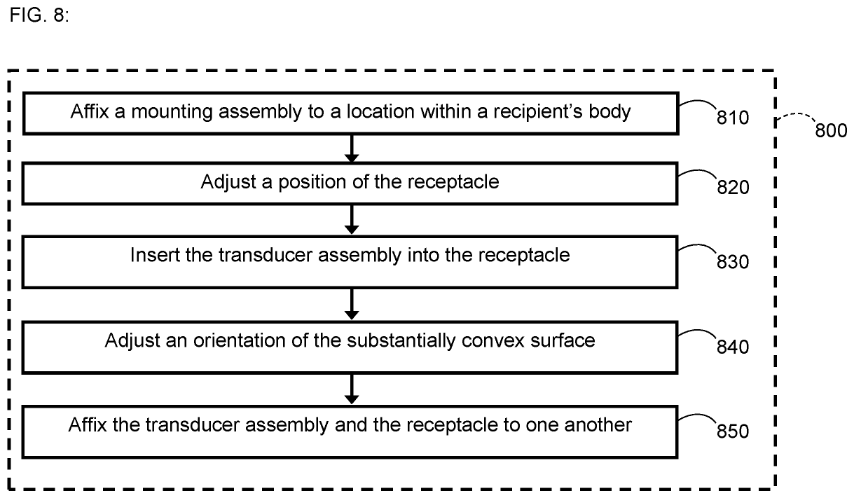

FIG. 8 is a flow diagram of an example method 800 in accordance with certain implementations described herein. While the example method 800 is described herein by referring to the example apparatus 300 of FIGS. 3A-3C, 4, 5, 6, and 7A-7D, other apparatuses are also compatible with the example method 800 in accordance with certain implementations described herein. For example, the method 800 described herein can be applied to any of a variety of implantable medical devices.

In an operational block 810, the method 800 comprises affixing a mounting assembly (e.g., fixation element 310) to a location (e.g., first location 352) within a recipient's body. The mounting assembly comprises a receptacle (e.g., socket 312) configured to receive a transducer assembly (e.g., transducer 320), the receptacle comprising a substantially concave surface (e.g., surface 340; first surface portion 610) and an opening (e.g., orifice 313) extending from the substantially concave surface through the receptacle. The substantially concave surface is substantially circular or spherical.

In an operational block 820, the method 800 further comprises adjusting a position of the receptacle such that the opening substantially faces a target portion (e.g., second location 354) of the recipient's body. For example, adjusting the position of the receptacle can comprise plastically deforming the second portion 316 of the fixation element 310. For another example, adjusting the position of the receptacle can comprise positioning the mounting assembly within the recipient's body before or while affixing the mounting assembly to the location. The adjustment of the position of the receptacle can comprise placing a dummy transducer assembly within the receptacle, the adjustment can be performed with the dummy transducer assembly within the receptacle, and the method 800 can further comprise replacing the dummy transducer assembly with the actual (e.g., operational) transducer assembly.

In an operational block 830, the method 800 further comprises inserting the transducer assembly into the receptacle with a substantially convex surface (e.g., second surface portion 620) of the transducer assembly engaging the substantially concave surface of the receptacle. The substantially convex surface is substantially circular or spherical. In certain implementations, the transducer assembly is inserted into the receptacle before the mounting assembly is affixed to the location within the recipient's body, while in certain other implementations, the transducer assembly is inserted into the receptacle after the mounting assembly is affixed to the location.

In an operational block 840, the method 800 further comprises adjusting an orientation of the substantially convex surface relative to the substantially concave surface. In certain implementations, the transducer assembly comprises an elongate element (e.g., connection apparatus 360; connection apparatus 216; rod; tube), inserting the transducer assembly into the receptacle comprises extending the elongate assembly through the opening, and adjusting the orientation comprises pointing the elongate element towards the target portion of the recipient's body. The method 800 of certain such implementations further comprises affixing a distal end of the elongate element to the target portion of the recipient's body such that mechanical vibrations generated by the transducer assembly propagate along the elongate element between the transducer assembly and the target portion of the recipient's body.

In an operational block 850, the method 800 further comprises affixing the transducer assembly and the receptacle to one another. In certain implementations, wherein affixing the transducer assembly and the receptacle to one another comprises clamping the receptacle to the transducer assembly (e.g., using a clamp) and/or applying an adhesive to the transducer assembly and the receptacle. In certain implementations, the method 800 further comprises linearly adjusting a position of the receptacle (e.g., using a slot and corresponding protrusion) to controllably modify a distance between the receptacle and the target portion of the recipient's body.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional auditory prostheses, various implementations described herein can be incorporated in a variety of other suitable devices, methods, and contexts. More generally, as can be appreciated, certain implementations described herein can be used in a variety of implantable medical device contexts that can benefit from having an adjustable orientation of at least a portion of the implanted device during implantation.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within +10% of, within +5% of, within +2% of, within +1% of, or within +0.1% of the stated amount. As another example, the terms “generally parallel” and “substantially parallel” refer to a value, amount, or characteristic that departs from exactly parallel by +10 degrees, by +5 degrees, by +2 degrees, by +1 degree, or by +0.1 degree, and the terms “generally perpendicular” and “substantially perpendicular” refer to a value, amount, or characteristic that departs from exactly perpendicular by +10 degrees, by +5 degrees, by +2 degrees, by +1 degree, or by +0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
a fixation element configured to be implanted within a portion of a recipient's body, the fixation element comprising a socket; and
a transducer configured to be implanted within the recipient's body and received by the socket, the transducer comprising:
a first end portion configured to transmit signals to and/or receive signals from a target portion of the recipient's body;
a second end portion opposite to the first end portion, the first and second end portions spaced from one another along a center longitudinal axis of the transducer; and
a surface at the first end portion or between the first and second end portions, the surface configured to be in mechanical communication with the socket with the center longitudinal axis of the transducer extending through the socket, the transducer configured to be rotated such that an angular orientation of the center longitudinal axis relative to the socket is controllably adjusted.

2. The apparatus of claim 1, wherein the socket comprises a substantially circularly or spherically curved first surface portion and the surface of the transducer comprises a substantially circularly or spherically curved second surface portion, the second surface portion configured to be in mechanical communication with and controllably positioned relative to the first surface portion.

3. The apparatus of claim 2, wherein one of the first surface portion and the second surface portion comprises a plurality of protrusions and the other of the first surface portion and the second surface portion comprises a plurality of recesses configured to mate with the plurality of protrusions such that the center longitudinal axis is positionable at a plurality of discrete angular orientations relative to the socket.

4. The apparatus of claim 1, wherein the transducer is a microphone configured to sense motion of the target portion of the recipient's body, the microphone comprising an optical sensor or a magnetic induction sensor.

5. The apparatus of claim 1, wherein the transducer is a microphone or an actuator, the apparatus further comprising a rod or wire configured to extend from the first end portion through an orifice of the socket and configured to be in mechanical communication with the target portion of the recipient's body such that mechanical vibrations propagate along the rod or wire between the transducer and the target portion of the recipient's body.

6. The apparatus of claim 1, wherein the target portion of the recipient's body comprises an ossicle, a portion of a cochlea, a portion of the otic capsule, or a semicircular canal of the recipient's body.

7. The apparatus of claim 1, wherein the fixation element is configured to be affixed to a portion of the recipient's skull with the socket within a middle ear region or a mastoid bone cavity of the recipient's body.

8. The apparatus of claim 1, wherein the fixation element further comprises a portion in mechanical communication with the socket, the portion configured to controllably adjust a position and/or an orientation of the socket relative to a target portion of the recipient's body during implantation of the apparatus.

9. The apparatus of claim 8, wherein the portion comprises a slot and a protrusion configured to mate with and controllably slide along the slot.

10. The apparatus of claim 8, wherein the portion comprises a first screw thread in mechanical communication with the socket and a second screw thread, the first screw thread configured to be screwed along the second screw thread.

11. The apparatus of claim 8, wherein the portion is configured to be plastically bent such that an orifice of the socket is coarsely pointed towards a target portion of the recipient's body.

12. A method comprising:
affixing a mounting assembly to a location within a recipient's body, the mounting assembly comprising a receptacle configured to receive a transducer assembly, the receptacle comprising a substantially concave surface and an opening extending from the substantially concave surface through the receptacle, the substantially concave surface being substantially circular or spherical;
adjusting a position of the receptacle such that the opening substantially faces a target portion of the recipient's body;
inserting the transducer assembly into the receptacle with a substantially convex surface of the transducer assembly engaging the substantially concave surface of the receptacle, the substantially convex surface being substantially circular or spherical;
adjusting an orientation of the substantially convex surface relative to the substantially concave surface; and
affixing the transducer assembly and the receptacle to one another.

13. The method of claim 12, wherein the transducer assembly comprises an elongate element, said inserting the transducer assembly into the receptacle comprises extending the elongate assembly through the opening, and said adjusting the orientation comprises pointing the elongate element towards the target portion of the recipient's body.

14. The method of claim 13, further comprising affixing a distal end of the elongate element to the target portion of the recipient's body such that mechanical vibrations generated by the transducer assembly propagate along the elongate element between the transducer assembly and the target portion of the recipient's body.

15. The method of claim 12, wherein affixing the transducer assembly and the receptacle to one another comprises clamping the receptacle to the transducer assembly.

16. The method of claim 12, wherein affixing the transducer assembly and the receptacle to one another comprises applying an adhesive to the transducer assembly and the receptacle.

17. The method of claim 12, further comprises linearly adjusting a position of the receptacle to controllably modify a distance between the receptacle and the target portion of the recipient's body.

18. The method of claim 12, wherein said adjusting the position of the receptacle comprises placing a dummy transducer assembly within the receptacle, and the method further comprises replacing the dummy transducer assembly with an operational transducer assembly.

19. An apparatus comprising:
a mounting assembly comprising:
a first portion configured to be affixed to a location of a recipient's body;
a second portion in mechanical communication with the first portion and configured to extend into a region of the recipient's body spaced from the location of the recipient's body; and
a receptacle in mechanical communication with the second portion, the receptacle comprising a first curved surface and an opening through the first curved surface, the receptacle configured to be in mechanical communication with a transducer assembly comprising a second curved surface configured to fit with the first curved surface and to be rotatably adjusted relative to the first curved surface, the transducer assembly configured to transmit signals to and/or receive signals from a target portion of the recipient's body along a line extending through the opening.

20. The apparatus of claim 19, further comprising the transducer assembly.

21. The apparatus of claim 19, wherein the line is coincident with a center longitudinal axis of an active component of the transducer assembly.

22. The apparatus of claim 21, wherein the active component comprises at least one of: actuator, microphone, optical sensor, magnetic induction sensor.

23. The apparatus of claim 19, wherein the second portion configured to be plastically deformed.

24. The apparatus of claim 19, wherein the second portion comprises a slot and the receptacle comprises a protrusion configured to mate with and to be controllably slid along the slot.

25. The apparatus of claim 19, wherein the second portion comprises a protrusion and the receptacle comprises a slot configured to mate with and to be controllably slid along the protrusion.

26. The apparatus of claim 25, further comprising a clamp configured to press against the second portion to keep the receptacle in place.

27. The apparatus of claim 19, wherein the second portion comprises:
a first substantially cylindrical portion in mechanical communication with the receptacle and having a first screw thread; and
a second substantially cylindrical portion in mechanical communication with the first portion and having a second screw thread configured to mate with the first screw thread such that rotation of the first substantially cylindrical portion relative to the second substantially cylindrical portion linearly adjusts the position of the receptacle.

28. The apparatus of claim 27, wherein the first screw thread is at an outside surface of the first substantially cylindrical portion and the second screw thread is at an inside surface of the second substantially cylindrical portion.

29. The apparatus of claim 27, wherein the first screw thread is at an inside surface of the first substantially cylindrical portion and the second screw thread is at an outside surface of the second substantially cylindrical portion.

30. The apparatus of claim 27, wherein the second portion comprises at least one locking screw configured to keep the first and second substantially cylindrical portions in place relative to one another.

31. The apparatus of claim 19, wherein one of the first curved surface and the second curved surface comprises a plurality of protrusions and the other of the first curved surface and the second curved surface comprises a plurality of recesses configured to mate with the plurality of protrusions such that the second curved surface is positionable at a plurality of discrete angular orientations relative to the first curved surface.
